(19) United States
(12) Patent Application Publication
(10) Pub. No.: US 2006/0263551 A1
(43) Pub. Date: Nov. 23, 2006

(54) PROCESS FOR MAKING INTEGRAL ELASTIC SUPPORTS AND SUPPORT OBTAINABLE BY SAID PROCESS

(75) Inventor: Stefano Tomeo, Vicenza (IT)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Selle Royal s.p.a.

(21) Appl. No.: 11/420,383

(22) Filed: May 25, 2006

Related U.S. Application Data
(63) Continuation of application No. PCT/IB04/03902, filed on Nov. 29, 2004.

(30) Foreign Application Priority Data
Nov. 27, 2003 (IT) VI2003A000236

(51) Int. Cl. B29C 44/12; B31B 45/00

(52) U.S. Cl. 428/34.1; 264/46.4

(57) ABSTRACT

The present invention provides a bodily support and particularly relates to a process for making integral elastic supports as well as supports obtainable by such process. A support according to the invention may be advantageously used as a component for the construction of vehicles, such as bicycles and motorcycles, but for pieces of furniture as well, such as chair seats and seat backs, stools and the like.

### CROSS-REFERENCE TO RELATED APPLICATIONS

This application is a continuation of International Application No. PCT/IB2004/003902, filed Nov. 29, 2004, which claims the benefit of Italian Application No. VI2003A000236, filed Nov. 27, 2003, both of which are incorporated by reference herein in their entirety.

### FIELD OF THE INVENTION

The present invention is generally applicable to the field of human body supports and particularly relates to a process for making integral elastic supports as well as to a support obtainable by such process.

The support according to the invention may be advantageously used as a component for the construction of vehicles, such as bicycles and motorcycles, but for pieces of furniture as well, such as chair seats and seat backs, stools and the like.

### BACKGROUND

A number of embodiments of saddles for bicycles or similar vehicles have an essentially rigid shell and a flexible covering that defines a seating surface. Also, one or more resilient filler layers are typically interposed between the covering and the shell.

US-A-6066277; US-A-2003164629; and WO-A-9937459 disclose similar processes for making a saddle which include at least one filler layer molding step. Particularly, each process provides prior construction of a rigid shell and the introduction thereof into a mold. This latter has an essentially convex portion which is adapted to support the shell and an essentially concave portion which is adapted to receive the filler layer material. Once the mold has been closed, with the shell therein, the material is caused to expand to form the filler layers, which are typically composed of one or more foam materials. Finally, the assembly thus obtained is removed from the mold.

An apparent drawback of this arrangement is that, while foam materials are being expanded, they not only properly deposit on the shell, but may also extend beyond the peripheral edge of the shell, and irregularly insinuates between the shell and the mold, thereby forming burrs. This is caused by a difference in size and shape tolerances between the shell and the mold, and is facilitated by the pressure exerted by foam materials during expansion.

Burrs generally have an irregular shape and might affect the aesthetic quality of the saddle. Therefore, an additional step is required for finishing the peripheral edges of the molded assembly, which causes an increase of manufacturing costs. Furthermore, the finishing step is generally carried out manually by an operator, which makes it particularly slow and expensive.

Another drawback of the above arrangements lies in that the filler layer portions in the proximity of the peripheral edge of the shell are exposed to fast wear and may be easily torn off. These peripheral portions of the filler layers generally have a comparatively little thickness and are repeatedly pressed against the rigid shell during use.

Yet, further processes are known for making saddles as described above. For instance, US-A-6116684 discloses a process in which two essentially flat laminated layers of materials are provided, -having different rigidities. Two appropriately shaped portions are cut out of these flat laminated layers, to be subsequently heated and introduced, in overlapped relationship, into a mold. In a molding step the two portions are conformed and joined together, thereby essentially providing the final shape of the saddle.

US-A-6409865 discloses a similar process, wherein the filler layer is first molded, whereupon a separate shell is heated and joined to such filler layer.

By using pre-shaped and pre-cut portions or by joining the shell and the pre-molded filler layer by heat, peripheral edge burrs may be reduced, but this involves the apparent disadvantage of a dramatic increase of manufacturing costs. In fact, the above processes include both at least one additional step for separately making the filler layer, wherefore auxiliary equipment is needed.

Another drawback associated with separate fabrication of the shell and the filler layer is that the attachment therebetween may be partial and defective, thereby affecting the performance of the finished saddle. DE-C1-4300376 discloses a method for manufacturing a cushioned seat with areas of different hardness. In this known method a foamable resin is introduced in the mould before forming the shell and the upper surface of the expanded resin delimits the moulding space for the shell. Moreover, the shell is formed in one single piece and provides no means to render the seat more resilient and comfortable and to reduce the imperfection in proximity of the junction areas between the filler layer and the shell.

### SUMMARY OF THE INVENTION

A primary object of this invention is to obviate the above drawbacks, while providing a cost-effective process and a cost-effective support structure.

A particular object is to provide a process that ensures high quality of finished products, as well as relatively short manufacturing times.

A further object of the invention is to provide a process that allows for simplifying fabrication and reducing manpower requirements, by at least partly suppressing manual operations.

Another particular object of the invention is to provide a support structure that is particularly comfortable during use.

Yet another object is to provide a support structure which maintains its features unchanged with time, and is less exposed to wear or scratching.

These objects, as well as others which will be more apparent hereafter, are achieved by providing a process for making integral elastic supports, such as chair seats, seat backs, arm rests, bicycle saddles and vehicle seats and the like. Each support is comprised of an essentially rigid or semirigid shell and at least one layer made of a resilient filler, optionally with a covering that defines a surface of contact with a user, wherein the process includes the steps of
a) making a shell with a predetermined shape and structure;
b) setting up a mold with at least one inner cavity and capable of being moved from an open condition to a closed condition;
c) introducing at least one foamable resin and the shell in the inner cavity of the mold;
d) foaming the resin to form a filler layer to be joined to the shell into a single assembly;
e) removing the assembly from the mold, characterized in that the shell is manufactured in a first step
a1) for making a main body having a peripheral edge and a second step
a2) for making a sealing member in the proximity of the peripheral edge, to essentially close any gap between the shell and the inner cavity in the proximity of the peripheral edge and prevent the formation of burrs as the foamable resin is foamed.

Thanks to this particular sequence of steps, any gap between the shell and the inner cavity in the proximity of said peripheral edge will be filled and the formation of burrs as the foamable resin is foamed with be avoided. In such a manner, a high quality support may be obtained, and manual operations may be reduced in the process, whereby manufacturing times and manpower requirements are also reduced.

According to another aspect of the invention, an integral elastic support is provided.

### BRIEF DESCRIPTION OF THE DRAWINGS

Further features and advantages of the invention will be more apparent from the detailed description of a few preferred, non-exclusive embodiments of a process and a support according to the invention, which are described as nonlimiting examples with the aid of the annexed drawings, in which:

FIG. 1 is a sectional view of the equipment that is used in one embodiment of the inventive process;

FIG. 2 is a sectional view of an integral elastic support according to the invention;

FIG. 3 shows a plurality of sections, as taken along parallel planes, of a component of the support of FIG. 2;

FIG. 4 is a perspective view of a component of the support of FIG. 2;

FIG. 5 is a sectional view of the equipment that is used in a further embodiment of the inventive process.

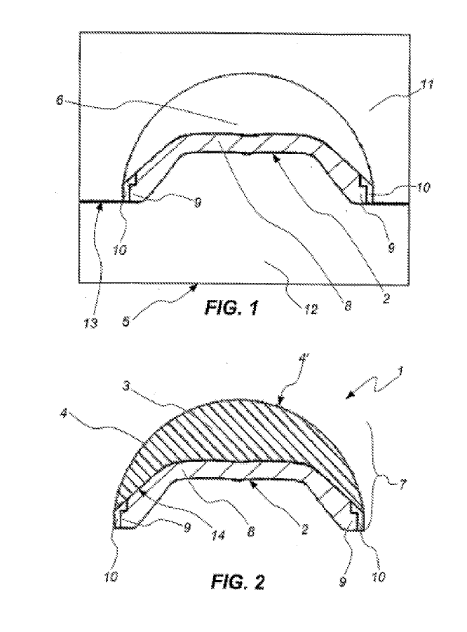

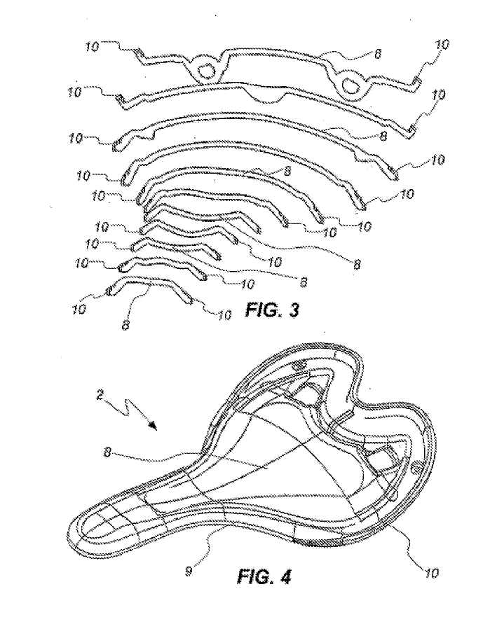

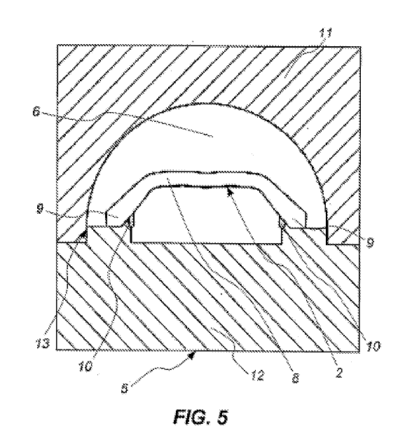

### DETAILED DESCRIPTION

Particularly referring to the above figures, a process for making an integral elastic support according to the invention is described, which is generally designated with numeral 1. Various supports 1 may be obtained by the process described below, such as chair seats, seat backs, arm rests, saddles and seats for bicycles and similar vehicles.

In greater detail, each support 1 comprises an essentially rigid or semirigid shell 2 and at least one layer 3 of a resilient filler. A cover 4 may be provided, which is designed to come in contact with a user, and defines a user contact surface 4′. Alternatively, the filler layer 3, with an adequate surface finish, might directly define a user contact surface 4′.

The process of the invention includes a first step a) in which the shell 2 is formed, with predetermined shape and structure. In a second step b), a mold 5 is set up, for forming the filler layer 3 on the shell 2. To this end, the mold 5 has at least one inner cavity 6 which has such shape and size as that the shell 2 may be received therein, and partly occupy the space thereof. In use, the inner cavity 6 may be moved from an open condition to a closed condition.

In a third step c), at least one foamable resin is introduced, together with the shell 2, into the inner cavity 6 of the mold 5. Then, in a fourth step d), the foamable resin is foamed to fill the inner cavity 6 and form the filler layer 3, to be joined with the shell 2 into a single assembly 7. Also, the foamable resin may be a polymeric resin, preferably a polyurethane resin.

Such foamable resin may be introduced into the mold 5 before or after the shell 2, but the foaming step is preferably carried out when both the shell 2 and the resin are within the mold 5.

Particularly, in a first embodiment, the resin is injected into the inner cavity 6 of the mold 5, when the shell 2 has already been introduced therein and the cavity 6 is in the closed condition.

Alternatively, in a second embodiment the resin is cast into the inner cavity 6 of the mold 5, before introducing the shell 2 therein and with the cavity 6 in the open condition.

In a further step e), the assembly 7 is removed from the mold 5.

A peculiar feature of the invention is that the shell 2 is manufactured in a first step a1) for making a main body 8 having a peripheral edge and a second step a2) for making a sealing member 10 in the proximity of the peripheral edge 9. Thus, the sealing member 10 essentially closes any gap between the shell 2 and the inner cavity 6 in the proximity of the peripheral edge 9 and prevents the formation of burrs as the foamable resin is foamed.

In order to obtain an easily handled and sturdy shell 2, the sealing member 10 may be hot-molded from a moldable material in the proximity of the peripheral edge 9. Thanks to this material molding step, the sealing member 10 may be essentially integral with the main body 8, which considerably limits the possibility that the sealing member 10 may be wholly or partly detached when the integral elastic support 1 is being fabricated and used.

Also, the moldable material of the sealing member 10 may be differentiated from the base material of the main body 8 in such a manner as to meet the different structural needs and functional requirements of the sealing member 10 and the main body 8. Particularly, this latter may have a comparatively high rigidity, whereas the sealing member 10 may be comparatively flexible. For proper molding of the sealing member 10, the moldable material may be selected amongst the materials that are chemically compatible with the base material of the main body 8. In greater detail, the moldable material may be of the polymeric type, preferably a thermoplastic rubber, which exhibits resiliency at the operating temperature and during foaming.

The mold 5 may comprise a female element 11, which reproduces the negative shape of the user contact surface 4′ and a male element 12 for supporting the shell 2. The female element 11 and the male element 12 are designed to be mutually coupled at a junction zone 13. They may be also spaced apart to move the inner cavity 6 into the open condition or be driven close together until they are joined at the junction zone 13 to move the inner cavity 6 into the closed condition.

According to a particular embodiment of the inventive process, when the inner cavity 6 is in the open condition, the shell 2 is mounted on the male element 12, and the resin is cast, preferably into the female element 11. Then, the female element 11 and the male element 12 are brought close together, thereby completing the introduction of the shell into the inner cavity 6.

In a further embodiment of the inventive process, the shell 2 is mounted on the male element 12 with the inner cavity 6 in the open condition and the female and male elements 11, 12 are driven close together until the inner cavity 6 is moved to the closed condition. Then, the foamable resin is injected therein and foamed.

The shell 2 may be coupled to the male element 12 in such a manner that the sealing member 10 is located in the proximity of the junction zone 13. Furthermore, while the foamable resin is being foamed, the sealing member 10 may be at least partly locked against the female element 11 as shown in FIG. 1, or against the male element 12, as shown in FIG. 5. This particular arrangement will maximize the effectiveness of the sealing member 10 in filling any gap between the shell 2 and the inner cavity 6 in the proximity of the peripheral edge 9.

The above process provides an integral elastic support 1 that may be advantageously used for chair seats, seat backs, arm rests, bicycle saddles and vehicle seats and the like.

The support 1 comprises a shell 2 made of an essentially rigid or semirigid base material and at least one layer 3 of a resilient filler, which is joined to the shell 2. A cover 4 may be further provided above the filler layer 3. The support 1 has a surface of contact 4′ with a user, which may be defined by the cover 4 or directly by an adequately surface-treated filler layer 3.

A peculiar features of the support 1 according to the invention is that the shell 2 comprises a main body 8 made of a comparatively rigid or semi-rigid base material, and having a peripheral edge 9 in the proximity of a junction zone 14 between the shell 2 and the filler layer 3. The shell 2 further comprises a sealing member 10 made of a comparatively flexible material, which is formed in the proximity of the peripheral edge 9 to prevent imperfections at the junction zone 14.

The elasticity of the sealing member 10 reduces the occurrence of damages to the covering 4 and/or the filler layer 3. In fact, the pressure cyclically and constantly exerted by the user on the user contact surface 4′ is at least partly absorbed by the elastic deformation of the sealing member 10. Without the latter, the cover 4 and/or the filler layer 3 would be directly pressed against the rigid or semi-rigid shell 2 and would be quickly damaged due to fretting. More particularly, the sealing member 10 may be essentially integral with the main body 8, thereby providing a particularly strong connection therebetween and perfect preservation of the functional characteristics of the support 1 with time.

Advantageously, the comparatively flexible material of the sealing member 10 may be a thermoplastic polymeric elastomer, whereas the comparatively rigid or semi-rigid base material of the main body 8 may be of various types. Preferably, the material of the main body 8 may be of the polymeric type, such as polypropylene, ABS, nylon, possibly reinforced with various fillers, such as carbon or glass fibers or the like. Suitably, the material of the main body 8 may also be a metal or ligneous material.

From the above disclosure, the process and support of the invention prove to achieve the proposed objects and particularly provide a high quality and long-lasting final product with lower manpower requirements and manufacturing costs.

The process and support of this invention are susceptible to a number of changes or variants, within the inventive concept disclosed in the annexed claims. All the details thereof may be replaced by other technically equivalent parts, and the materials may vary depending on different needs, without departure from the scope of the invention.

While the process and support have been described with particular reference to the accompanying figures, the numerals referred to in the disclosure and claims are only used for the sake of a better intelligibility of the invention and shall not be intended to limit the claimed scope in any manner.

1. A process for forming an integral elastic support comprising a shell, a filler material, and a user contact surface, wherein the process comprises:
a) providing a shell with a predetermined shape and structure, said shell being manufactured according to a process comprising:
1) forming a main body having a peripheral edge, said main body comprising a first material that is rigid or semi-rigid; and
2) forming a sealing member in the proximity of said peripheral edge, said sealing member being formed of a second material different from said first material and that is resilient in nature;
b) providing a mold with at least one inner cavity movable from an open condition to a closed condition;
c) introducing said shell followed by at least one foamable resin into the inner cavity of said mold;
d) foaming said resin to form said filler layer to be joined to the shell into a single assembly; and
e) removing said assembly from the mold.

2. A process as claimed in claim 1, wherein said second material has a resiliency during said foaming step so as to close any gap between said shell and the inner cavity of said mold in the proximity of said peripheral edge and to prevent the formation of burrs as the foamable resin is foamed.

3. A process as claimed in claim 1, wherein said second material is moldable and chemically compatible with said first material forming said main body.

4. A process as claimed in claim 3, wherein said moldable material is a polymeric material.

5. A process as claimed in claim 1, wherein said sealing member is essentially integral with said main body.

6. A process as claimed in claim 5, wherein said peripheral sealing member is hot-molded on said main body in the proximity of said peripheral edge.

7. A process as claimed in claim 1, wherein said mold comprises a female element reproducing the negative shape of the user contact surface and a male element for supporting said shell.

8. A process as claimed in claim 7, wherein said female and male elements are designed to be mutually coupled at a junction zone, thereby defining said inner cavity.

9. A process as claimed in claim 8, wherein said shell is coupled to said male element so that said sealing member is located in the proximity of said junction zone.

10. A process as claimed in claim 9, wherein said sealing member is at least partly locked against said female element during said foaming step.

11. A process as claimed in claim 9, wherein said sealing member is at least partly locked against said male element during said foaming step.

12. A process as claimed in claim 1, wherein said resin is injected into the inner cavity of said mold when said cavity is in the closed condition.

13. A process as claimed in claim 1, wherein said resin is cast into the inner cavity of said mold with said cavity in the open condition.

14. An integral elastic support formed according to the process of claim 1, said integral elastic support comprising:
a) a shell formed of:
i) a main body comprising a rigid or semi-rigid material and having a peripheral edge, and
ii) a sealing member comprising a comparatively flexible material and being formed in the proximity of said peripheral edge;
b) a resilient filler material joined to said shell; and
c) a user contact surface.

15. An integral elastic support as claimed in claim 14, wherein said sealing member is adapted for preventing imperfections at a junction zone between said shell and said resilient filler material joined to said shell.

16. An integral elastic support as claimed in claim 14, wherein said sealing member is adapted for preventing damages to said user contact surface and said filler arising from fretting of said user contact surface or said filler against said shell.

17. An integral elastic support as claimed in claim 14, wherein said sealing member is essentially integral with said main body.

18. An integral elastic support as claimed in claim 14, wherein said comparatively flexible material comprises a thermoplastic polymeric elastomer.

19. An integral elastic support as claimed in claim 14, wherein said rigid or semi-rigid material comprises a polymeric material, a metal material, or ligneous material.

20. An integral elastic support as claimed in claim 14, wherein said support is selected from the group consisting of chair seats, seat backs, arm rests, bicycle saddles, and vehicle seats.
